(19) United States
(12) Patent Application Publication
(10) Pub. No.: US 2020/0013307 A1
(43) Pub. Date: Jan. 9, 2020

(54) FLIGHT SIMULATION METHOD BASED ON MULTI-SENSOR DATA FUSION, DEVICE, AND APPARATUS

(71) Applicant: SZ DJI TECHNOLOGY CO., LTD., Shenzhen (CN)

(72) Inventors: Chaobin CHEN, Shenzhen (CN); Zhaoliang PENG, Shenzhen (CN)

(21) Appl. No.: 16/572,239

(22) Filed: Sep. 16, 2019

Related U.S. Application Data
(63) Continuation of application No. PCT/CN2017/078969, filed on Mar. 31, 2017.

(51) Int. Cl. G09B 9/24; G09B 9/10; G05D 1/00; B64C 39/02

(52) U.S. Cl. CPC G09B 9/24; G09B 9/10; G05D 1/0016; B64C 2201/146; G05D 1/0094; B64C 39/024; G05D 1/0022

(57) ABSTRACT

A flight simulation method includes obtaining a flight simulator start command transmitted by a flight simulation control terminal and starting a flight simulator in response to the flight simulator start command. The flight simulation method also includes generating multi-sensor simulation data based on pre-set multi-sensor model parameters and ground truth simulation data output by the flight simulator. The flight simulation method also includes fusing the multi-sensor simulation data to generate simulated multi-sensor fused data. The flight simulation method further includes generating a flight simulation control command based on the simulated multi-sensor fused data.

### CROSS-REFERENCE TO RELATED APPLICATION

This application is a continuation application of International Application No. PCT/CN2017/078969, filed on Mar. 31, 2017, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of flight simulation and, more particularly, to a flight simulation method based on multi-sensor data fusion, a device, an unmanned aerial vehicle, and a flight simulation system.

### BACKGROUND

As unmanned aerial vehicles (“UAV”) are increasingly implemented, UAV flight simulators are also increasingly implemented in teaching, gaming, surveying, development of software development kit (“SDK”), etc. For example, in applications (“Apps”) parameter adjustment software for consumer-level UAVs, a simulator function may be provided. A user may operate the UAV in the simulator to familiarize with the basic functions and basic operations of the product. The user may also set certain common abnormal scenes. The user may learn how to deal with the abnormal scenes, thereby enhancing the safety consciousness and operation skills in actual flight. In addition, in the process of developing UAV applications, the simulator is an indispensable core element. During the development process, a developer may use the simulator to perform adjustments and verification to visually observe the effect of the application being developed, thereby increasing the efficiency of development and enhancing the flight safety.

Currently available simulators obtains the ground truth only through calculations based on models, and directly use the attitude, velocity, latitude and longitude included in the ground truth to perform control and logic related operations. A disadvantage of the currently available simulators is the lack of sensor models. Thus, the simulators cannot simulate characteristics of the sensors, such as noise, delay, and various malfunctioning scenarios (e.g., data jam, lose of connection, abrupt change, etc.), thereby causing relatively large differences between the simulation effect and the actual flight. In addition, the currently available simulators cannot simulate switch between sensors under the redundancy situation. Furthermore, a conventional simulation method lacks a data fusion process, and therefore, cannot verify algorithms and functions relating to fusion of multiple sensors. The above disadvantages limit the applications of the currently available simulators.

### SUMMARY

The present disclosure provides a flight simulation method based on multi-sensor data fusion, a device, a UAV, and a flight simulation system. The present disclosure can realize flight simulation under different characteristics of multiple sensors. The present disclosure can improve the degree of simulation (e.g., the degree of simulating the reality), increase the efficiency of developing the UAV, and improve flight safety.

In accordance with an aspect of the present disclosure, there is provided a flight simulation method. The flight simulation method includes obtaining a flight simulator start command transmitted by a flight simulation control terminal and starting a flight simulator in response to the flight simulator start command. The flight simulation method also includes generating multi-sensor simulation data based on pre-set multi-sensor model parameters and ground truth simulation data output by the flight simulator. The flight simulation method also includes fusing the multi-sensor simulation data to generate simulated multi-sensor fused data. The flight simulation method further includes generating a flight simulation control command based on the simulated multi-sensor fused data.

In accordance with another aspect of the present disclosure, there is provided a flight simulation method. The flight simulation method includes obtaining a flight simulator start command and starting a flight simulator in response to the flight simulator start command. The flight simulation method also includes generating multi-sensor simulation data based on pre-set multi-sensor model parameters and ground truth simulation data output by the flight simulator. The flight simulation method also includes fusing the multi-sensor simulation data to generate simulated multi-sensor fused data. The flight simulation method further includes generating a flight simulation control command based on the simulated multi-sensor fused data.

In accordance with another aspect of the present disclosure, there is provided a flight simulation system. The flight simulation system includes an unmanned aerial vehicle. The flight simulation system also includes a flight simulator. The flight simulation system also includes a multi-sensor data simulator. The flight simulation system further includes a flight simulation control terminal. The unmanned aerial vehicle is configured to connect with the flight simulator, the multi-sensor data simulator, and the flight simulation control terminal. The unmanned aerial vehicle includes a data fusion processor, a logic function processor, and a data communication processor. The data communication processor is configured to obtain a flight simulator start command transmitted by the flight simulation control terminal, and to start the flight simulator in response to the flight simulator start command. The multi-sensor data simulator is configured to generate multi-sensor simulation data based on pre-set multi-sensor model parameters and ground truth simulation data output by the flight simulator. The data fusion processor is configured to fuse the multi-sensor simulation data to generate simulated multi-sensor fused data. The logic function processor is configured to generate a flight simulation control command based on the simulated multi-sensor fused data.

In various embodiments of the present disclosure, the simulation data of the ground truth output by the flight simulator are fused with the model parameters of the multiple sensors to generate multi-sensor simulation data. The multi-sensor simulation data may be converted into multi-sensor fused data through data fusion. A flight simulation control command and a corresponding propulsion output command may be generated based on the multi-sensor fused data. The propulsion output command may be used to control the flight simulator to perform flight simulation. By adjusting the multi-sensor model parameters, flight simulation may be performed using various different multi-sensor characteristics, thereby improving the degree of simulation, increasing the efficiency of developing the UAV, and improving flight safety.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram of a flight simulation system, according to an example embodiment.

FIG. 2 is a flow chart illustrating a flight simulation method, according to an example embodiment.

FIG. 3 is a flow chart illustrating a flight simulation method, according to another example embodiment.

FIG. 4 is a schematic diagram of a flight simulation device, according to an example embodiment.

FIG. 5 is a schematic diagram of a UAV, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

In the present disclosure, relational terms such as first and second, etc., are only used to distinguish an entity or operation from another entity or operation, and do not necessarily imply that there is an actual relationship or order between the entities or operations. Therefore, a “first” or “second” feature may include, explicitly or implicitly, one or more such features. The term “multiple” means two or more than two, unless otherwise defined.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The term “communicatively coupled” or “communicatively connected” indicates that related items are coupled or connected through a communication chancel, such as a wired or wireless communication channel.

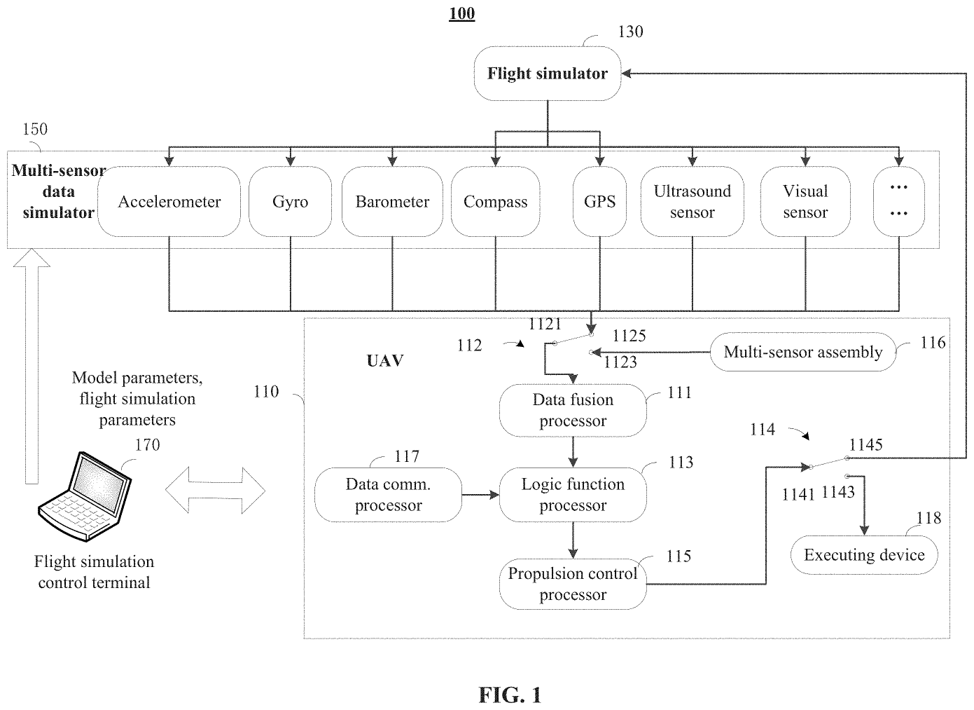

FIG. 1 is a schematic diagram of a flight simulation system 100 based on multi-sensor data fusion. The flight simulation system 100 may be used to perform flight simulation for a UAV to verify the flight stability of the UAV under different characteristics of multiple sensors.

The flight simulation system 100 may include a UAV 110, a flight simulator 130, a multi-sensor data simulator 150, and a flight simulation control terminal 170. The UAV 110 may be communicatively coupled or connected with the flight simulator 130, the multi-sensor data simulator 150, and the flight simulation control terminal 170. The communication connection may be established via direct connections with connecting interfaces using signal cables. In some embodiments, the communication connection may be established using wireless communication devices (e.g., Bluetooth, Wi-Fi, etc.). The connected devices or entities may communicate with one another to exchange data or signals.

In some embodiments, the UAV 110 may be remotely controlled by a user to fly to a target region to perform specified tasks. For example, the UAV 110 may carry an imaging device to enable the user to perform surveillance of the target region. In some embodiments, the UAV 110 may be implemented in disaster rescue, geographical survey, etc. In some embodiments, the user may configure the control conditions for the time and/or distance, such that the UAV that carries working assemblies such as the imaging device and sprayers can control the working assemblies based on the pre-set time and pre-set distance. For example, the UAV may control the imaging device to capture images at pre-set time and/or pre-set distance, and may control the sprayers to spray pesticides at the pre-set time and/or pre-set distance. In addition to the imaging device and the sprayers, the UAV may carry other working assemblies such as radar, infrared device, etc.

In some embodiments, the flight simulator 130 may be configured to receive a propulsion output command, and may be controlled under the propulsion output command to perform flight simulation. The flight simulation may generate flight status simulation data and ground truth simulation data. The flight simulator 130 may include a dynamics and/or kinematics model of the UAV. The model may receive the propulsion output command and simulate various flight statuses of the UAV. The model may output flight status simulation data and the ground truth simulation data.

In some embodiments, the multi-sensor data simulator 150 may be configured to generate multi-sensor simulation data based on pre-set multi-sensor model parameters and the ground truth simulation data. The multi-sensor data simulator 150 may include a sensor model (or multi-sensor model) having one or more sensors including, but not limited to, an accelerometer, a gyroscope, a barometer, an ultrasound sensor, a global positioning system (“GPS”) sensor, a compass, a visual sensor, etc. Different sensors may have different models. The sensor model may be configured to receive the ground truth simulation data output by the flight simulator 130, and perform internal processes (e.g., data conversion, delay, noise superposition, biasing, etc.) of the ground truth simulation data using the pre-set multi-sensor model parameters to generate and output the multi-sensor simulation data. In some embodiments, the pre-set multi-sensor model parameters may include type of noise, power, delay, mounting locations, non-linear characteristics, etc.

In some embodiments, different model parameters define different characteristics of a sensor (or sensors) (hence the parameters may also be referred to as characteristic parameters). By adjusting one or more characteristic parameters of the pre-set multi-sensor model parameters, the characteristics of the corresponding sensor may be changed. Thus, the flight stability of the UAV when the sensors are configured with different characteristic parameters may be verified. In addition, by changing the characteristic parameters of one or more sensors included in the pre-set multi-sensor model parameters, pre-set malfunctions may be injected in the one or more sensors included in the multi-sensor data simulator 150. As such, the flight simulation system 100 may verify the performance of the multi-sensor data simulator 150 in malfunction diagnosis and algorithm isolation.

In some embodiments, the UAV 110 may include a data fusion processor 111, a logic function processor 113, a propulsion control processor 115, and a data communication processor 117. The data fusion processor 111 may be configured to receive the multi-sensor simulation data output by the multi-sensor data simulator 150. The data fusion processor 111 may be configured to fuse the multi-sensor simulation data to generate the multi-sensor fused data. The logic function processor 113 may be configured to receive the simulated multi-sensor fused data output by the data fusion processor 111. Based on the simulated, multi-sensor fused data, the logic function processor 113 may be configured to generate a flight simulation control command for the propulsion control processor 115. The propulsion control processor 115 may generate a propulsion output command for the flight simulator 130 based on the flight simulation control command. The data communication processor 117 may be configured to transmit flight status simulation data output by the flight simulator 130 to the flight simulation control terminal 170. The flight simulation control terminal 170 may be configured to display the flight simulation.

In some embodiments, the flight simulation control terminal 170 may include, but not be limited to, a personal computer, a cell phone, a tablet, etc. In some embodiments, the flight simulation control terminal 170 may also be a dedicated communication terminal configured for display and control the flight simulation. In some embodiments, the flight simulation control terminal 170 may be communicatively connected with the UAV 110 through a wired connection (e.g., through a universal serial bus (“USB”)), or a wireless connection (e.g., through Bluetooth or Wi-Fi). The flight simulation control terminal 170 may include a three-dimensional (“3D”) image display engine. When the flight simulation control terminal 170 receives the fight status simulation data output by the flight simulator 130, the 3D image display engine of the flight simulation control terminal 170 may dynamically display the simulated UAV and the 3D images of the simulated flight environment.

In some embodiments, the UAV 110 may include a first switch 112, a second switch 114, an actual multi-sensor assembly 116, and an actual executing device 118. The first switch 112 and the second switch 114 may include an electrically controlled switch having three connection terminals. The first switch 112 and the second switch 114 may be configured to switch input data sources for the data fusion processor 111 (i.e., for a data fusion process) and to switch the control objects of the propulsion control processor 115 (i.e., for a propulsion control process), respectively. The actual multi-sensor assembly 116 may include multiple sensors, including, but not limited to, a speedometer, a gyroscope, a barometer, an ultrasound sensor, a GPS sensor, a compass, or a visual sensor. The actual executing device 118 may include at least one of a motor or a steering gear of the UAV 110. The actual executing device 118 may be configured to receive and execute the propulsion output command output by the propulsion control processor 115.

In some embodiments, the first switch 112 may be connected with the data fusion processor 111, and may selectively connect the data fusion processor 111 with the actual multi-sensor assembly 116 or the multi-sensor data simulator 150. The first switch 112 may be configured to switch the input data for the data fusion processor 111 between the multi-sensor data output by the actual multi-sensor assembly 116 and the multi-sensor simulation data output by the multi-sensor data simulator 150. In some embodiments, the first switch 112 may include a first connection terminal 1121, a second connection terminal 1123, and a third connection terminal 1125. The first connection terminal 1121 may be connected with a data input terminal of the data fusion processor 111. The second connection terminal 1123 may be connected with a data output terminal of the actual multi-sensor assembly 116. The third connection terminal 1125 may be connected with an output terminal of the multi-sensor data simulator 150.

In some embodiments, the first connection terminal 1121 may be switched to be connected with the second connection terminal 1123 or the third connection terminal 1125. When the UAV 110 is operating normally, the first connection terminal 1121 may be connected with the second connection terminal 1123. The input data of the data fusion processor 111 may be the actual multi-sensor data output by the actual multi-sensor assembly 116, i.e., the data relating to the actual working environment acquired by multiple sensors included in the multi-sensor assembly 116. When the UAV 110 is in a flight simulation status, the first connection terminal 1121 may switch to connect with the third connection terminal 1125. The input data of the data fusion processor 111 may be the multi-sensor simulation data output by the multi-sensor data simulator 150.

In some embodiments, the second switch 114 may be connected with the propulsion control processor 115, and may selectively connect the propulsion control processor 115 with the actual executing device 118 or the flight simulator 130. The second switch 114 may be configured to switch the control objects of the propulsion control processor 115 between the actual executing device 118 or the flight simulator 130. In some embodiments, the second switch 114 may include a first connection terminal 1141, a second connection terminal 1143, and a third connection terminal 1145. The first connection terminal 1141 may be connected with a command output terminal of the propulsion control processor 115. The second connection terminal 1143 may be connected with a command input terminal of the actual executing device 118. The third connection terminal 1145 may be connected with a command input terminal of the flight simulator 130.

In some embodiments, the first connection terminal 1141 may be switched to connect with the second connection terminal 1143 or the third connection terminal 1145. When the UAV 110 is operating normally, the first connection terminal 1141 may be connected with the second connection terminal 1143. The control object of the propulsion control processor 115 may be the actual executing device 118 of the UAV 110. When the UAV 110 is in a flight simulation status, the first connection terminal 1141 may be switched to connect with the third connection terminal 1145. The control object of the propulsion control processor 115 may be the flight simulator 130.

In some embodiments, the flight simulation control terminal 170 may be configured to transmit a flight simulator start command to the UAV 110 for starting the flight simulator. After the UAV 110 receives the flight simulator start command, the UAV 110 may store the flight simulator start command in a storage medium (e.g., an Electrically Programmable read only memory (“EPROM”), a secure digital (“SD”) card, a flash card, etc.). The flight status simulation data of the flight simulator may be reset through at least one of a hardware restart or a software restart. In some embodiments, the flight simulator may be restarted. After the restart, the UAV 110 may retrieve the command for starting the flight simulator from the storage medium, to further control the first switch 112 to switch the input data of the data fusion processor 111 from the multi-sensor data output by the actual multi-sensor processor 116 to the multi-sensor simulation data output by the multi-sensor simulator 150. The UAV 110 may also control the second switch 114 to switch the control object of the propulsion control processor 115 of the UAV from the actual executing device 118 of the UAV 110 to the flight simulator 130, and may start the flight simulator 130 to perform flight simulations.

In some embodiments, in a flight simulation, the flight simulation control terminal 170 may transmit a configuration command for revising a flight simulation parameter to the flight simulator 130, thereby controlling the flight simulator 130 to change the flight simulation parameter, such as changing the weight of the UAV, changing the wind speed, injecting malfunction, etc. In some embodiments, the flight simulation control terminal 170 may transmit a characteristic parameter modifying command to modify one or more characteristic parameters of one or more sensors included in the multi-sensor data simulator 150. Based on the modified one or more characteristic parameters and the flight status simulation data, the flight simulation system 100 may verify the flight stability of the UAV when the sensors are configured with different characteristic parameters. In some embodiments, the flight simulation system 100 may verify, based on the modified one or more characteristic parameters and the flight status simulation data, the stability of the data fusion algorithm when the sensors are configured with different characteristic parameters. In some embodiments, the flight simulation control terminal 170 may transmit a characteristic parameter modifying command for modifying, editing, or changing one or more characteristic parameters of the multi-sensor model, to thereby inject pre-set malfunction into the one or more sensors included in the multi-sensor model. Based on the pre-set malfunction and the flight status simulation data, the performance of the multi-sensor data simulator 150 in malfunction diagnosis and algorithm isolation can be verified.

In some embodiments, after finishes the flight simulation, the flight simulation control terminal 170 may transmit an exit command for exiting the flight simulator to the UAV 110. After receiving the exit command for exiting the flight simulator, the UAV 110 may perform operations to exit the flight simulation. In some embodiments, the first switch 112 may be controlled to switch the input data of the data fusion processor 111 from the multi-sensor simulation data output by the multi-sensor data simulator 150 to the actual multi-sensor data output by the actual multi-sensor assembly 116. The second switch 114 may be controlled to switch the control object (i.e., the recipient of the propulsion output command) of the propulsion control processor 115 from the flight simulator 130 to the actual executing device 118 of the UAV.

In some embodiments, the flight simulator 130 and the multi-sensor data simulator 150 may be disposed inside the UAV 110, or outside of the UAV 110 such as in a separate flight simulation device, such as a computer, a smart phone, a tablet, or a dedicated flight simulation platform. When the flight simulator 130 and the multi-sensor data simulator 150 are disposed in a separate flight simulation device, the flight simulation device may transmit the multi-sensor simulation data output by the multi-sensor data simulator 150 to the UAV 110 through a communication channel or link. The UAV may process the multi-sensor simulation data may be processed by the UAV 110 through data fusion to generate a corresponding propulsion output command, and may transmit the propulsion output command to the flight simulator 130 of the flight simulation device through the communication channel. In some embodiments, the flight simulator 130 may be disposed in an external flight simulation device outside of the UAV 110. The external flight simulation device may transmit the ground truth data output by the flight simulator 130 to the UAV 110 through the communication channel. The UAV 110 may transmit the propulsion output command to the flight simulator 130 of the flight simulation device through the communication channel. In some embodiments, the communication channel may be a wired or wireless communication channel.

In some embodiments, because the UAV 100 may experience some theoretically unpredictable situations in actual operations, the flight simulator 130 may be used to simulate particular scenes and generate particular input data for controlling the UAV 110 to perform flight simulation.

In some embodiments, by including the fusion of the multi-sensor model and data during the flight simulation process, the flight simulation may be closer to actual flight scenarios. In addition, with the presence of the multi-sensor model, malfunction and functions of the sensors may be simulated. The present disclosure may provide a user with more simulation scenes. The present disclosure may simulate the performance of the UAV under multi-sensor data, such as altitude determination based on ultrasound, visual obstacle avoidance, etc. The present disclosure provided multiple advanced functions to the user. In addition, by including the fusion of the multi-sensor model and the data in a flight simulation, the present disclosure provides a software developer with closer-to-reality simulation effect, thereby increasing the efficiency of development and improving flight safety.

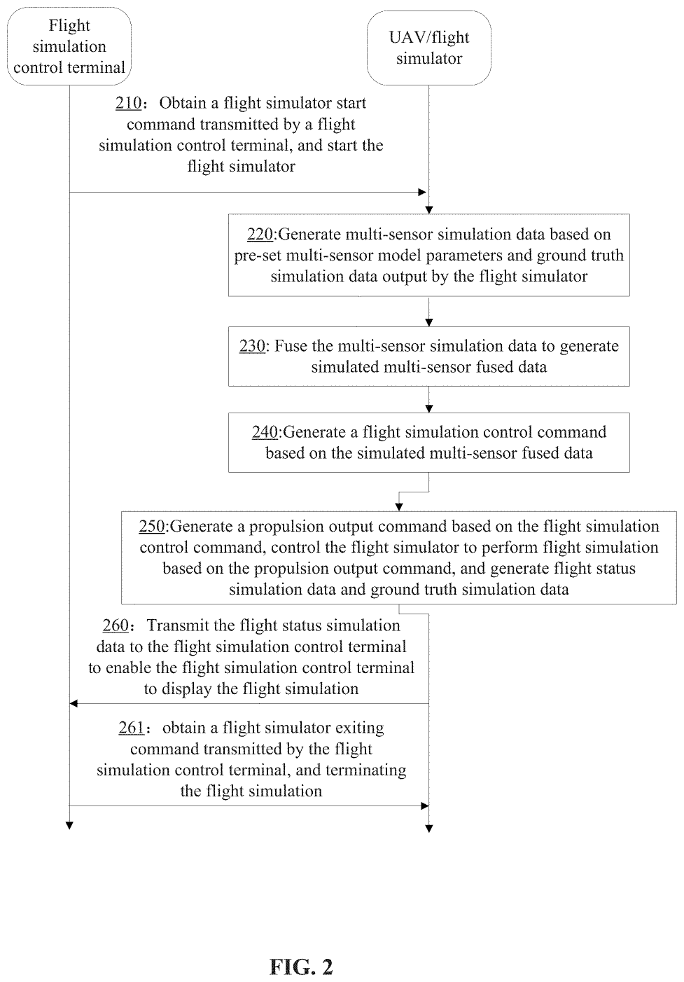

In some embodiments, as shown in FIG. 2, a flight simulation method based on multi-sensor data fusion is provided. The method may be implemented in the flight simulation system 100 of FIG. 1. The method may include at least the following steps:

Step 210: obtaining a flight simulator start command transmitted by a flight simulation control terminal, and starting the flight simulator;

Step 220: generating multi-sensor simulation data based on pre-set multi-sensor model parameters and ground truth simulation data output by the flight simulator;

Step 230: fusing the multi-sensor simulation data to generate simulated multi-sensor fused data;

Step 240: generating a flight simulation control command based on the simulated multi-sensor fused data;

Step 250: generating a propulsion output command based on the flight simulation control command, controlling the flight simulator to perform flight simulation based on the propulsion output command, and generating flight status simulation data and ground truth simulation data;

Step 260: transmitting the flight status simulation data to the flight simulation control terminal to enable the flight simulation control terminal to display the flight simulation.

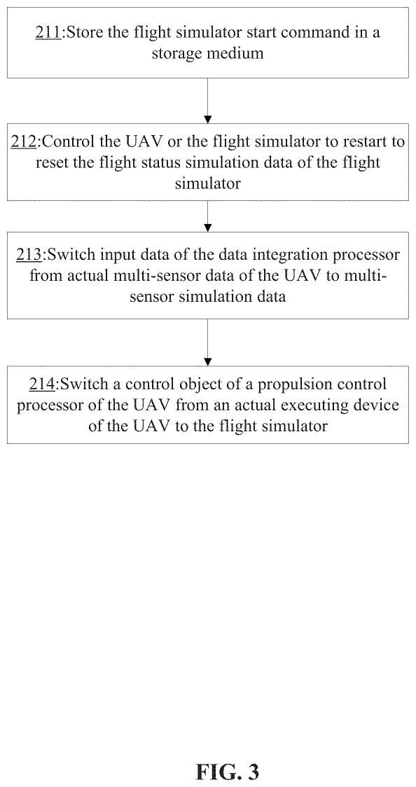

As shown in FIG. 3, in some embodiments, after obtaining the flight simulator start command transmitted by the flight simulation control terminal, and before starting the flight simulator, the method may also include:

Step 211: storing the flight simulator start command in a storage medium;

Step 212: controlling the UAV or the flight simulator to restart to reset the flight status simulation data of the flight simulator; the restart may include at least one of a hardware restart or a software restart;

Step 213: switching input data of the data fusion processor from actual multi-sensor data of the UAV to multi-sensor simulation data;

Step 214: switching a control object of a propulsion control processor of the UAV from an actual executing device of the UAV to the flight simulator.

In some embodiments, controlling the flight simulator to perform flight simulation based on the propulsion output command may include:

obtaining a flight simulation parameter setting command transmitted by the flight simulation control terminal;

controlling, based on the flight simulation parameter setting command, the flight simulator to change one or more flight simulation parameters.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and modifying, changing, editing, or revising the one or more characteristic parameters of one or more sensors included in the multi-sensor model; and

verifying, based on the modified one or more characteristic parameters and the flight status simulation data, a flight stability of the UAV when the sensors are configured with different characteristic parameters.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and modifying, changing, editing, or revising the one or more characteristic parameters of one or more sensors included in the multi-sensor model; and

verifying, based on the modified one or more characteristic parameters and the flight status simulation data, a stability of a data fusion algorithm when the sensors are configured with different characteristic parameters.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and injecting pre-set malfunction in one or more sensors included in the multi-sensor model; and

verifying, based on the pre-set malfunction and the flight status simulation data, a performance of the multi-sensor model in malfunction diagnosis and algorithm isolation.

In some embodiments, referring back to FIG. 2, after the flight simulation purposes are accomplished, the method may also include step 261: obtaining a flight simulator exiting command transmitted by the flight simulation control terminal, and terminating the flight simulation. After the flight simulation is terminated, the method may also include switching the input data of the data fusion processor to the actual multi-sensor data of the UAV, and switching the recipient of the propulsion output command to the actual executing device of the UAV.

In some embodiments, the detailed implementation of the various steps of the flight simulation methods may refer to the descriptions of the various embodiments shown in FIG. 1.

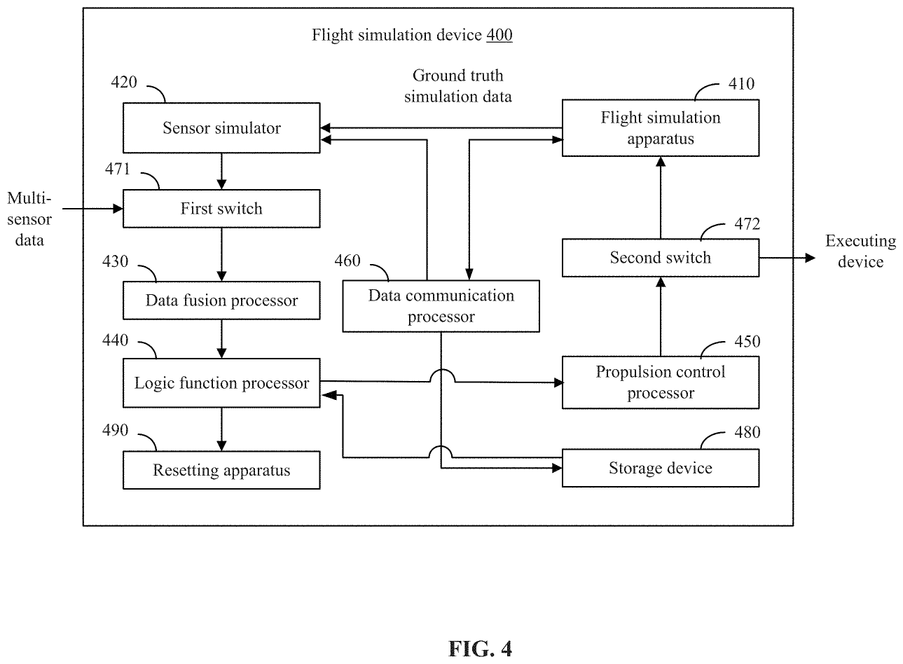

In some embodiments, as shown in FIG. 4, the present disclosure also provides a flight simulation device 400 that is based on multi-sensor data fusion. The flight simulation device 400 may include:

a flight simulation apparatus 410 configured to obtain a flight simulator start command transmitted from the flight simulation control terminal, and to start the flight simulator;

a sensor simulator 420 configured to generate multi-sensor simulation data based on the pre-set multi-sensor model parameters and the ground truth simulation data output by the flight simulator;

a data fusion processor 430 configured to fuse the multi-sensor simulation data to generate multi-sensor fused data;

a logic function processor 440 configured to generate a flight simulation control command based on the simulated multi-sensor fused data;

a propulsion control processor 450 configured to generate a propulsion output command based on the flight simulation control command, to control the flight simulator to perform flight simulation based on the propulsion output command, and to generate flight status simulation data and ground truth simulation data;

a data communication processor 460 configured to transmit the flight status simulation data to the flight simulation control terminal to enable the flight simulation control terminal to display the flight simulation.

In some embodiments, the flight simulation device 400 may also include:

a first switch 471 configured to switch the input data for the data fusion processor from the multi-sensor data of the UAV to the multi-sensor simulation data;

a second switch 472 configured to switch the control object of the propulsion control processor of the UAV from the executing device of the UAV to the flight simulator.

In some embodiments, the flight simulation device 400 may also include:

a storage device 480 configured to store the flight simulator start command in a storage medium;

a resetting apparatus 490 configured to control the UAV or the flight simulator to restart to thereby reset the flight status simulation data of the flight simulator; the restart may include at least one of a hardware restart or a software restart.

In some embodiments, the flight simulation apparatus 410 may be configured to:

obtain the flight simulation parameter setting command transmitted by the flight simulation control terminal;

control the flight simulator to change one or more flight simulation parameters based on the flight simulation parameter setting command.

In some embodiments, the flight simulation apparatus 410 may also be configured to:

obtain a characteristic parameter modifying command for modifying one or more characteristic parameters of a multi-sensor model transmitted by the flight simulation control terminal, and modify, change, edit, or revise the one or more characteristic parameters of one or more sensors included in the multi-sensor model;

based on the modified one or more characteristic parameters and the flight status simulation data, verify flight stability of the UAV when the sensors are configured with different characteristic parameters.

In some embodiments, the flight simulation apparatus 410 may also be configured to:

obtain a characteristic parameter modifying command for modifying one or more characteristic parameters of a multi-sensor model transmitted by the flight simulation control terminal, and modify, change, edit, or revise the one or more characteristic parameters of one or more sensors included in the multi-sensor model; and

based on the modified one or more characteristic parameters and the flight status simulation data, verify stability of a data fusion algorithm when the sensors are configured with different characteristic parameters.

In some embodiments, the flight simulation apparatus 410 may also be configured to:

obtain a characteristic parameter modifying command for modifying one or more characteristic parameters of a multi-sensor model transmitted by the flight simulation control terminal, and inject pre-set malfunction in one or more sensors included in the multi-sensor model; and

based on the pre-set malfunction and the flight status simulation data, verify a performance of the multi-sensor model in malfunction diagnosis and algorithm isolation.

In some embodiments, the various commands obtained by the flight simulation apparatus 410 may be received by the data communication processor 460 and the data communication processor 460 may transmit the received commands to the flight simulation apparatus 410.

In some embodiments, the detailed functions of the various elements, components, devices, or processors included in the flight simulation device 400 and their implementations may refer to the descriptions of the embodiments shown in FIG. 1.

Referring back to FIG. 2, in some embodiments, the present disclosure provides a flight simulation method based on multi-sensor data fusion. The method may be implemented at the UAV. The UAV may include the flight simulator. The flight simulation method may include at least the following steps:

obtaining a flight simulator start command, and starting the flight simulator;

generating multi-sensor simulation data based on the pre-set multi-sensor model parameters and the ground truth simulation data output by the flight simulator;

fusing the multi-sensor simulation data to generate multi-sensor fused data; and

generating a flight simulation control command based on the simulated multi-sensor integration data.

In some embodiments, after generating the flight simulation control command based on the simulated multi-sensor fused data, the method may also include:

generating a propulsion output command based on the flight simulation control command, controlling the flight simulator to perform flight simulation based on the propulsion output command, and generating flight status simulation data and ground truth simulation data;

transmitting the flight status simulation data to the flight simulation control terminal to enable the flight simulation control terminal to display the flight simulation.

Referring back to FIG. 3, in some embodiments, after obtaining the flight simulator start command transmitted by the flight simulation control terminal, and before starting the flight simulator, the method may also include:

switching the input data of the data fusion processor from the actual multi-sensor data of the UAV to multi-sensor simulation data;

switching the control object of the propulsion control processor of the UAV from the actual executing device of the UAV to the flight simulator.

In some embodiments, before switching the input data of the data fusion processor from the actual multi-sensor data of the UAV to multi-sensor simulation data, the method may also include:

storing the flight simulator start command in a storage medium;

controlling the UAV or the flight simulator to restart to thereby reset the flight status simulation data of the flight simulator; the restart may include at least one of a hardware restart or a software restart.

In some embodiments, controlling the flight simulator to perform flight simulation based on the propulsion output command may include:

obtaining a flight simulation parameter setting command transmitted by the flight simulation control terminal;

controlling the flight simulator to change one or more flight simulation parameters based on the flight simulation parameter setting command.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and modifying, changing, editing, or revising the one or more characteristic parameters of one or more sensors included in the multi-sensor model; and

based on the modified one or more characteristic parameters and the flight status simulation data, verifying flight stability of the UAV when the sensors are configured with different characteristic parameter.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and modifying, changing, editing, or revising the one or more characteristic parameters of one or more sensors included in the multi-sensor model; and

based on the modified one or more characteristic parameters and the flight status simulation data, verifying stability of a data fusion algorithm when the sensors are configured with different characteristic parameters.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and injecting pre-set malfunction in one or more sensors included in the multi-sensor model; and

based on the pre-set malfunction and the flight status simulation data, verifying a performance of the multi-sensor model in malfunction diagnosis and algorithm isolation.

In some embodiments, the flight simulation method may also include:

obtaining a flight simulator exiting command transmitted by the flight simulation control terminal;

exiting the flight simulator, switching the input data of the data fusion processor to actual multi-sensor data of the UAV, and switching the recipient of the propulsion output command to the actual executing device of the UAV.

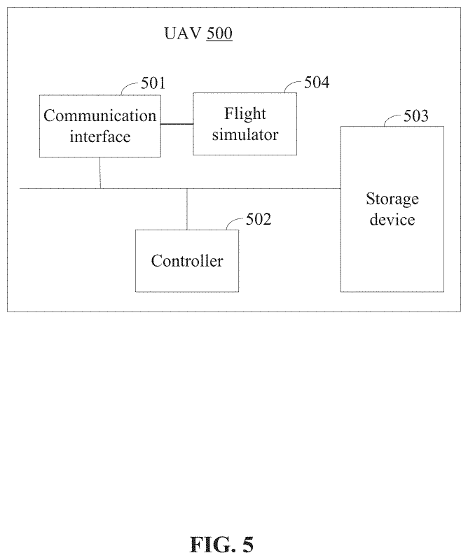

Referring to FIG. 5, in some embodiments, the present disclosure provides a UAV 500. The UAV 500 may include various components that are not shown, such as a propeller, a power supply, a landing stand. In some embodiments, the UAV 500 may also include a communication interface 501, a controller 502, a storage device 503, and a flight simulator 504. The controller 502 may be configured to establish a communication connection with the flight simulator 504 through the communication interface 501. The communication interface 501, the controller 502, and the storage device 503 may be electrically connected. The flight simulator 504 may be disposed in the body of the UAV 500 or outside of the body of the UAV 500. In some embodiments, the flight simulator 504 may be separately and independently disposed from body of the UAV 500, and may be communicatively connected with various components or elements included in or on the body of the UAV 500 through wired or wireless communication.

In some embodiments, the communication interface 501 may be connected with a remote control device at a ground terminal, and may receive data transmitted from the ground terminal. The data received may include at least one of: a flight control command for the UAV, various parameters configured by a user through the remote control device, various control conditions or control logic generated by the remote control device, etc.

In some embodiments, the communication interface 501 may be communicatively connected with the flight simulation control terminal, and may be configured to receive various commands transmitted by the flight simulation control terminal, such as the flight simulator start command, the flight simulation parameter setting command, and the characteristic parameter modifying command, etc. The communication interface 501 may be configured to transmit the flight status simulation data generated by the flight simulator 504 to the flight simulation control terminal.

In some embodiments, the storage device 503 may include a volatile memory, such as a random-access memory (“RAM”). The storage device 503 may also include a non-volatile memory, such as a flash memory. The storage device 503 may include a combination of various memories.

In some embodiments, the controller 502 may include a central processing unit (“CPU”). The CPU may include a hardware chip. The hardware chip may include an application-specific integrated circuit (“ASIC”), a programmable logic device (“PLD”), or any combination thereof. The PLD may include at least one of a complex programmable logic device (“CPLD”), a field-programmable gate array (“FPGA”), etc.

In some embodiments, the storage device 503 may be configured to store executable program codes, instructions, or commands. The controller 502 may retrieve the executable program codes, instructions, or commands from the storage device 503, and may perform the disclosed flight simulation methods that are based on multi-sensor data fusion.

In some embodiments, the controller may retrieve the executable program codes, instructions, or commands stored in the storage device 503, and may perform the following operations:

obtaining a flight simulator start command transmitted by the flight simulation control terminal, and starting the flight simulator;

generating multi-sensor simulation data based on the pre-set multi-sensor model parameters and the ground truth simulation data output by the flight simulator;

fusing the multi-sensor simulation data to generate simulated multi-sensor fused data;

generating a flight simulation control command based on the simulated multi-sensor fused data.

In some embodiments, after generating the flight simulation control command based on the simulated multi-sensor fused data, the operations may also include:

generating a propulsion output command based on the flight simulation control command, controlling the flight simulator to perform flight simulation based on the propulsion output command, and generating the flight status simulation data and the ground truth simulation data; and

transmitting the flight status simulation data to the flight simulation control terminal to enable the flight simulation control terminal to display the flight simulation.

In some embodiments, after obtaining the flight simulator start command transmitted by the flight simulation control terminal, and before starting the flight simulator, the operations may also include:

switching the input data of the data fusion processor from the actual multi-sensor data of the UAV to multi-sensor simulation data;

switching the control object of the propulsion control processor of the UAV from the actual executing device of the UAV to the flight simulator.

In some embodiments, before switching the input data of the data fusion processor from the actual multi-sensor data of the UAV to multi-sensor simulation data, the operations may also include:

storing the flight simulator start command in a storage medium;

controlling the UAV or the flight simulator to restart to thereby reset the flight status simulation data of the flight simulator; the restart may include at least one of a hardware restart or a software restart.

In some embodiments, controlling the flight simulator to perform flight simulation based on the propulsion output command may include:

obtaining a flight simulation parameter setting command transmitted by the flight simulation control terminal;

controlling the flight simulator to change one or more flight simulation parameters based on the flight simulation parameter setting command.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and modifying, changing, editing, or revising the one or more characteristic parameters of one or more sensors included in the multi-sensor model; and

based on the modified one or more characteristic parameters and the flight status simulation data, verifying flight stability of the UAV when the sensors are configured with different characteristic parameter.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and modifying, changing, editing, or revising the one or more characteristic parameters of one or more sensors included in the multi-sensor model; and

based on the modified one or more characteristic parameters and the flight status simulation data, verifying stability of a data fusion algorithm when the sensors are configured with different characteristic parameters.

In some embodiments, controlling the flight simulator to perform flight simulation based on the propulsion output command may include:

obtaining a characteristic parameter modifying command for modifying one or more characteristic parameters of a multi-sensor model transmitted by the flight simulation control terminal, and injecting pre-set malfunction in one or more sensors included in the multi-sensor model; and

based on the pre-set malfunction and the flight status simulation data, verifying a performance of the multi-sensor model in malfunction diagnosis and algorithm isolation.

In some embodiments, the operations may also include:

obtaining a flight simulator exiting command transmitted by the flight simulation control terminal;

exiting the flight simulator, switching the input data of the data fusion processor to actual multi-sensor data of the UAV, and switching the recipient of the propulsion output command to the actual executing device of the UAV.

In some embodiments, the detailed functions and implementations of various operations executed by the controller 502 may refer to the related descriptions of the embodiments shown in FIG. 1.

In various embodiments of the present disclosure, the simulation data of the ground truth output by the flight simulator are fused with the model parameters of the multiple sensors to generate multi-sensor simulation data. The multi-sensor simulation data may be converted into multi-sensor fused data through data fusion. A flight simulation control command and a corresponding propulsion output command may be generated based on the multi-sensor fused data. The propulsion output command may be used to control the simulator to perform flight simulation. By adjusting the multi-sensor model parameters, flight simulation may be performed using various different multi-sensor characteristics, thereby improving the degree of simulation, increasing the efficiency of developing the UAV, and improving flight safety.

A person having ordinary skill can appreciate that all or some of the steps of the disclosed methods may be implemented through hardware that implements the computer program code. The computer program code may be stored in a computer-readable storage medium. When the computer program code is executed, the steps of the disclosed methods may be performed. The non-transitory computer-readable storage medium can be any medium that can store program codes, for example, a magnetic disk, an optical disk, a read-only memory (“ROM”), and a random-access memory (“RAM”), etc.

The above descriptions of various embodiments are illustrative, and do not limit the scope of the present disclosure. A person having ordinary skills in the art can make changes, modifications, substitutions, and variations based on the present disclosure. The scope of the present disclosure is defined by the following claims and the equivalents.

What is claimed is:

1. A flight simulation method, comprising:
obtaining a flight simulator start command transmitted by a flight simulation control terminal and starting a flight simulator in response to the flight simulator start command;
generating multi-sensor simulation data based on pre-set multi-sensor model parameters and ground truth simulation data output by the flight simulator;
fusing the multi-sensor simulation data to generate simulated multi-sensor fused data; and
generating a flight simulation control command based on the simulated multi-sensor fused data.

2. The flight simulation method of claim 1, wherein after generating the flight simulation control command based on the simulated multi-sensor fused data, the method also comprises:
generating a propulsion output command based on the flight simulation control command, controlling the flight simulator to perform flight simulation based on the propulsion output command, and generating flight status simulation data; and
transmitting the flight status simulation data to the flight simulation control terminal to enable the flight simulation control terminal to display the flight simulation.

3. The flight simulation method of claim 2, wherein after obtaining the flight simulator start command transmitted by the flight simulation control terminal, and before starting the flight simulator, the method further comprises:
switching input data of a data fusion process from actual multi-sensor data of an unmanned aerial vehicle to the multi-sensor simulation data; and
switching a control object of a propulsion control process from an actual executing device of the unmanned aerial vehicle to the flight simulator.

4. The flight simulation method of claim 2, wherein controlling the flight simulator to perform flight simulation based on the propulsion output command comprises:
obtaining a flight simulation parameter setting command transmitted by the flight simulation control terminal; and
controlling the flight simulator to change one or more flight simulation parameters based on the flight simulation parameter setting command.

5. The flight simulation method of claim 3, wherein before switching input data of the data fusion processor from actual multi-sensor data of the unmanned aerial vehicle to the multi-sensor simulation data, the method further comprises:
storing the flight simulator start command in a storage medium; and
controlling the unmanned aerial vehicle or the flight simulator to restart to reset the flight status simulation data of the flight simulator,
wherein the restart comprises at least one of a hardware restart or a software restart.

6. The flight simulation method of claim 3, wherein controlling the flight simulator to perform flight simulation based on the propulsion output command comprises:
obtaining a characteristic parameter modifying command for modifying one or more characteristic parameters of a multi-sensor model transmitted by the flight simulation control terminal;
modifying the one or more characteristic parameters of one or more sensors included in the multi-sensor model; and
verifying, based on the modified one or more characteristic parameters and the flight status simulation data, a flight stability of the unmanned aerial vehicle when the one or more sensors are configured with different characteristic parameters.

7. The flight simulation method of claim 3, wherein controlling the flight simulator to perform flight simulation based on the propulsion output command comprises:
obtaining a characteristic parameter modifying command for modifying one or more characteristic parameters of a multi-sensor model transmitted by the flight simulation control terminal;
modifying the one or more characteristic parameters of one or more sensors included in the multi-sensor model; and
verifying, based on the modified one or more modified characteristic parameters and the flight status simulation data, a stability of a data fusion algorithm when the one or more sensors are configured with different characteristic parameters.

8. The flight simulation method of claim 3, wherein controlling the flight simulator to perform flight simulation based on the propulsion output command comprises:
obtaining a characteristic parameter modifying command for modifying one or more characteristic parameters of a multi-sensor model transmitted by the flight simulation control terminal;
injecting a pre-set malfunction into the one or more sensors included in the multi-sensor model; and
verifying, based on the pre-set malfunction and the flight status simulation data, a performance of the multi-sensor model in malfunction diagnosis and algorithm isolation.

9. A flight simulation method, comprising:
obtaining a flight simulator start command and starting a flight simulator in response to the flight simulator start command;
generating multi-sensor simulation data based on pre-set multi-sensor model parameters and ground truth simulation data output by the flight simulator;
fusing the multi-sensor simulation data to generate simulated multi-sensor fused data; and
generating a flight simulation control command based on the simulated multi-sensor fused data.

10. The flight simulation method of claim 9, after fusing the multi-sensor simulation data to generate the simulated multi-sensor fused data, the method further comprises:
generating a propulsion output command based on the flight simulation control command, controlling the flight simulator to perform flight simulation based on the propulsion output command, and generating flight status simulation data; and
transmitting the flight status simulation data to a flight simulation control terminal.

11. The flight simulation method of claim 10, wherein after obtaining the flight simulator start command transmitted by the flight simulation control terminal and before starting the flight simulator, the method further comprises:
switching input data of a data fusion process from actual multi-sensor data of an unmanned aerial vehicle to multi-sensor simulation data; and
switching a control object of a propulsion control process of the unmanned aerial vehicle from an actual executing device of the unmanned aerial vehicle to the flight simulator.

12. The flight simulation method of claim 10, wherein controlling the flight simulator to perform flight simulation based on the propulsion output command further comprises:
obtaining a flight simulation parameter setting command transmitted by the flight simulation control terminal; and
controlling the flight simulator to change one or more flight simulation parameters based on the flight simulation parameter setting command.

13. The flight simulation method of claim 10, wherein controlling the flight simulator to perform flight simulation based on the propulsion output command further comprises:
obtaining a characteristic parameter modifying command for modifying one or more characteristic parameters of a multi-sensor model transmitted by the flight simulation control terminal;
modifying the one or more characteristic parameters of one or more sensors included in the multi-sensor model; and
verifying, based on the modified one or more characteristic parameters and the flight status simulation data, a flight stability of the unmanned aerial vehicle when the one or more sensors are configured with different characteristic parameters.

14. The flight simulation method of claim 10, wherein controlling the flight simulator to perform flight simulation based on the propulsion output command further comprises:
obtaining a characteristic parameter modifying command for modifying one or more characteristic parameters of a multi-sensor model transmitted by the flight simulation control terminal;
modifying the one or more characteristic parameters of one or more sensors included in the multi-sensor model; and
verifying, based on the modified one or more characteristic parameters and the flight status simulation data, a stability of a data fusion algorithm when the one or more sensors are configured with different characteristic parameters.

15. The flight simulation method of claim 10, wherein controlling the flight simulator to perform flight simulation based on the propulsion output command comprises:
obtaining a characteristic parameter modifying command for modifying one or more characteristic parameters of a multi-sensor model transmitted by the flight simulation control terminal;
injecting a pre-set malfunction into the one or more sensors included in the multi-sensor model; and
verifying, based on the pre-set malfunction and the flight status simulation data, a performance of the multi-sensor model in malfunction diagnosis and algorithm isolation.

16. A flight simulation system, comprising:
an unmanned aerial vehicle;
a flight simulator;
a multi-sensor data simulator; and
a flight simulation control terminal,
wherein the unmanned aerial vehicle is configured to connect with the flight simulator, the multi-sensor data simulator, and the flight simulation control terminal, the unmanned aerial vehicle comprising a data fusion processor, a logic function processor, and a data communication processor,
wherein the data communication processor is configured to obtain a flight simulator start command transmitted by the flight simulation control terminal, and to start the flight simulator in response to the flight simulator start command,
wherein the multi-sensor data simulator is configured to generate multi-sensor simulation data based on pre-set multi-sensor model parameters and ground truth simulation data output by the flight simulator,
wherein the data fusion processor is configured to fuse the multi-sensor simulation data to generate simulated multi-sensor fused data, and
wherein the logic function processor is configured to generate a flight simulation control command based on the simulated multi-sensor fused data.

17. The flight simulation system of claim 16, wherein the unmanned aerial vehicle further comprises:
a propulsion control processor configured to generate a propulsion output command based on the flight simulation control command, control the flight simulator to perform flight simulation based on the propulsion output command, and generate flight status simulation data,
wherein the data communication processor is also configured to transmit the flight status simulation data to the flight simulation control terminal.

18. The flight simulation system of claim 17, wherein the unmanned aerial vehicle further comprises:
a first switch;
a second switch;
an actual multi-sensor assembly; and
an actual executing device,
wherein the first switch is configured to selectively connect the data fusion processor with the actual multi-sensor assembly or the multi-sensor data simulator, and to switch input data of the data fusion processor from actual multi-sensor data output by the actual multi-sensor assembly to multi-sensor simulation data output by the multi-sensor data simulator, and
wherein the second switch is configured to selectively connect the propulsion control processor with the actual executing device or the flight simulator, and to switch a control object of the propulsion control processor of the unmanned aerial vehicle from the actual executing device of the unmanned aerial vehicle to the flight simulator.

19. The flight simulation system of claim 17, wherein before switch the input data of the data fusion processor from the actual multi-sensor data output of the unmanned aerial vehicle to the multi-sensor simulation data, the unmanned aerial vehicle is further configured to:
store the flight simulator start command in a storage medium; and
reset the flight status simulation data of the flight simulator through at least one of a hardware restart or a software restart.

20. The flight simulation system of claim16, wherein the flight simulator is further configured to:
obtain a flight simulation parameter setting command transmitted by the flight simulation control terminal; and
change one or more flight simulation parameters based on the flight simulation parameter setting command.
